(19) United States
(12) Patent Application Publication
(10) Pub. No.: US 2016/0208350 A1
(43) Pub. Date: Jul. 21, 2016

(54) SMELTING APPARATUS AND METHOD OF USING THE SAME

(71) Applicant: NSGI, Montreal (CA)

(72) Inventors: Ian COX, East Amherst, NY (US); Enrico DI CESARE, Montreal (CA)

(21) Appl. No.: 15/023,178

(22) PCT Filed: Sep. 29, 2014
(86) PCT No.: PCT/CA2014/000711

§ 371 Date: Mar. 18, 2016

Related U.S. Application Data
(60) Provisional application No. 61/883,673, filed on Sep. 27, 2013.

(51) Int. Cl. C21B 11/08; F27B 3/19; F27B 3/20; C21B 13/10; F27B 3/24; F27B 3/02; C22B 5/12; F27B 3/18; F27B 3/22

(52) U.S. Cl. CPC C21B 11/08; F27B 3/18; F27B 3/19; F27B 3/20; F27B 3/22; F27B 3/24; F27B 3/02; C22B 5/12; C21B 13/10

(57) ABSTRACT

The present document describes a smelting apparatus for smelting metallic ore. The smelting apparatus comprises a furnace having a continuous curved wall and end walls defining a longitudinal volume having a longitudinal axis in a horizontal direction. The continuous curved wall has a lowermost area. The longitudinal volume is divided in at least three longitudinal layers comprising a top layer within which gasified fuel is combusted for creating a hot gas composition at a temperature sufficient to release, from the metallic ore, at least molten metal and slag, a lowermost layer at the lowermost area for holding molten metal, and a mid layer above the lowermost layer in which the slag accumulates.

### CROSS-REFERENCE TO RELATED APPLICATIONS

This application claims priority of U.S. provisional patent application No. 61/883,673, filed on Sep. 27, 2013, the specification of which is hereby incorporated by reference.

### BACKGROUND

(a) Field

The subject matter disclosed generally relates to smelting apparatus and to smelting processes. More particularly, the subject matter relates to smelting furnaces for iron ore smelting and processes for smelting iron ore.

(b) Related Prior Art

Smelting is a form of extractive metallurgy. Its main use is to produce a metal from its ore. This includes production of silver, iron, copper and other base metals from their ores. Smelting uses heat and a chemical reducing agent to decompose the ore, driving off other elements as gasses or slag and leaving just the metal behind. The reducing agent is commonly a source of carbon such as coke, or charcoal. The carbon, or carbon monoxide derived from it, removes oxygen from the ore, leaving behind elemental metal. The carbon is thus oxidized in two stages, producing first carbon monoxide and then carbon dioxide. As most ores are impure, it is often necessary to use flux, such as limestone, to remove the accompanying rock gangue as slag.

Plants for the electrolytic reduction of aluminum are also generally referred to as smelters. These do not melt aluminum oxide but instead dissolve it in aluminum fluoride. They normally use carbon electrodes, but novel smelter designs use electrodes that are not consumed in the process. The end product is molten aluminum.

Smelting involves more than just melting the metal out of its ore. Most ores are a chemical compound of the metal with other elements, such as oxygen (i.e., an oxide), sulfur (i.e., a sulfide) or carbon and oxygen together (i.e., a carbonate). To produce the metal, these compounds have to undergo a chemical reaction. Smelting therefore consists of using suitable reducing substances that will combine with those oxidizing elements to free the metal.

Current smelting furnace designs are more than often either tall vertical cylinders or rectangular boxes. Both result in either high construction costs for the tall cylindrical approach or on-going operational, and maintenance refractory costs for rectangular box designs (refractory is not stable in box type designs).

Numerous types of furnaces exist on the market. In an example, U.S. Pat. No. 6,537,342 describes an apparatus for a metal reduction and melting process, in which a metal and carbon-containing burden is heated in an induction furnace including a heating vessel in which the burden can float in at least one heap on a liquid metal bath in the vessel. The apparatus is characterized in that it includes at least one induction heater or inductor located at the bottom center line of the vessel, with the longitudinal access oriented perpendicular to the access of the vessel. The furnace is electrically heated from the outside (via induction means).

Even if U.S. Pat. No. 6,537,342 provides a cylindrical design to its furnace, it leads to an inefficient way of providing heat to the furnace (i.e., heat needs to travel towards the wall of the furnace as well as through the refractory material before heating the interior of the furnace).

In another example, U.S. Pat. No. 6,146,437 describes a metal containing compound reduction and melting process which entails feeding a burden made of a mixture of the metal containing compound and a suitable reductant in particulate form into an electrically heatable vessel which contains a bath of the metal in liquid form so that a reaction zone is formed in the burden in which the metal containing compound is reduced and a melting zone is formed below the reaction zone in which the reduced metal is melted. The furnace is electrically heated from the outside (via electrical means).

Even if U.S. Pat. No. 6,146,437 provides a cylindrical design to its furnace, it leads to an inefficient way of providing heat to the furnace (i.e., heat needs to travel towards the wall of the furnace as well as through the refractory material before heating the interior of the furnace). Use of electrical heating is both costly and inefficient.

In another example, U.S. Pat. No. 5,411,570 describes a method of making steel, by heating in a channel type induction furnace an iron containing burden and carbon, the carbon being included in the burden and/or contained in hot metal, and maintaining the temperature of the liquid product so formed above its liquidus temperature by controlling the amount of heat supplied to the furnace and/or the rate at which the burden is added to the furnace.

Even if U.S. Pat. No. 5,411,570 provides a cylindrical design to its furnace, it leads to an inefficient way of providing heat to the furnace (i.e., heat needs to travel towards the wall of the furnace as well as through the refractory material before heating the interior of the furnace).

There is therefore a need for an improved smelting apparatus and for a method of operating the same.

### SUMMARY

According to an embodiment, there is provided a smelting apparatus for smelting metallic ore, the smelting apparatus comprising a furnace having a continuous curved wall and end walls defining a longitudinal volume having a longitudinal axis in a horizontal direction, the continuous curved wall having a lowermost area, wherein the longitudinal volume is divided in at least three longitudinal layers comprising a top layer within which gasified fuel is combusted for creating a hot gas composition at a temperature sufficient to release, from the metallic ore, at least molten metal and slag, a lowermost layer at the lowermost area for holding molten metal, and a mid layer above the lowermost layer in which the slag accumulates.

According to an aspect, the continuous curved wall forms a cylinder.

According to an aspect, the continuous curved wall forms an edgeless curve.

According to an aspect, the apparatus further comprises a raw material inlet within the continuous curved wall in fluid communication with the top layer for supplying the metallic ore to the furnace.

According to an aspect, the apparatus further comprises a combustion air inlet within the continuous curved wall in fluid communication with the top layer for providing air for inducing combustion in the furnace.

According to an aspect, the apparatus further comprises a molten metal outlet in the lowermost area of the continuous curved wall in fluid communication with the lowermost layer for allowing molten metal to exit the furnace continuously and selectively.

According to an aspect, byproduct gases are released from the metallic ore and hot gas composition, and further wherein the continuous curved wall comprises an uppermost area which comprises a byproduct hot gas outlet fluidly connected to the furnace providing an exit from the furnace for the byproduct gases.

According to an aspect, the apparatus further comprises a fuel inlet within the continuous curved wall in fluid communication with the top layer for supplying a fuel to the furnace and a hot gas inlet within the continuous curved wall in fluid communication with the top layer for supplying a hot gas to the furnace for gasifying the fuel and thereby producing the gasified fuel.

According to an aspect, the apparatus further comprises a hot gas generator for providing gasified fuel and a gasified fuel inlet within the continuous curved wall in fluid communication with the top layer for supplying gasified fuel to the furnace.

According to an aspect, the furnace comprises an interior surface, the interior surface being lined with a refractory material.

According to an aspect, the apparatus further comprises a cooling system operatively connected to the furnace for cooling an exterior surface of the furnace.

According to an embodiment, there is provided a method for smelting a metallic ore comprising within a furnace having a continuous curved wall and end walls defining a longitudinal volume having a longitudinal axis in a horizontal direction, combusting a gasified fuel for creating a hot gas composition at a temperature to release, from the metallic ore a molten metal.

According to an aspect, the apparatus further comprises further comprising charging a raw material to the furnace prior oxidizing the gasified fuel.

According to an aspect, the apparatus further comprises supplying a fuel to the furnace; and supplying a hot gas to the furnace for gasifying the fuel prior combusting the gasified fuel.

According to an aspect, the apparatus further comprises supplying gasified fuel to the furnace.

According to an aspect, the apparatus further comprises cooling an exterior surface of the furnace.

According to an embodiment, there is provided a smelting apparatus for smelting metallic ores, the smelting apparatus comprising: a horizontally oriented cylindrical furnace; a raw material inlet operatively connected to the furnace for providing a raw material in the furnace at least one of: a fuel inlet operatively connected to the furnace for providing a fuel in the furnace and a hot gas inlet operatively connected to the furnace for providing a hot gas in the furnace for gasifying the fuel, the gasified fuel for reacting with the raw material; and a hot gas generator for reacting with the raw material; a combustion air inlet operatively connected to the furnace for providing combustion air in the furnace; and a molten metal outlet operatively connected to the furnace for allowing molten metal to continuously exit the furnace; wherein when in operation, the fuel is gasified to create a hot fuel gas that is combusted by the combustion air, thereby creating a hot gas composition and a temperature to release the molten metal from its ore and to smelt the metallic ores.

According to another embodiment, the furnace comprises an interior surface, the interior surface being refractory lined.

According to a further embodiment, at least one of the fuel inlet, the hot gas inlet, the combustion air inlet, the hot gas generator and the molten metal outlet respectively comprises a plurality of fuel inlets, a plurality of hot gas inlets, a plurality of combustion air inlets, a plurality of hot gas generator and a plurality of molten metal outlets as a function of overall length or diameter of the furnace.

According to yet another embodiment, the smelting apparatus further comprises a byproduct hot gas outlet operatively connected to the furnace for providing byproduct hot gas to exit the furnace.

According to another embodiment, the smelting apparatus further comprises a cooling system operatively connected to the furnace for cooling an exterior surface of the furnace.

According to a further embodiment, the furnace defines an interior diameter and further wherein the interior diameter varies from about 3 meters to about 6 meters.

According to another embodiment, the furnace defines a length and further wherein the length varies from about 6 meters to about 30 meters.

According to yet another embodiment, the fuel comprises a lump carbonaceous fuel.

According to another embodiment, the lump carbonaceous fuel comprises at least one of: coal, petcoke, coke and biomass carbon.

According to a further embodiment, the hot gas comprises natural gas.

According to yet another embodiment, the raw material comprises iron ore.

According to another embodiment, there is provided a method for smelting a metallic ore comprising: within a horizontally oriented cylindrical furnace, oxidizing a gasified hot fuel for creating a hot gas composition and a temperature to release a molten metal from its ore and to smelt the metallic ore; and continuously providing the molten metal to exit the furnace.

According to another embodiment, the method further comprises: charging a fuel to the furnace; and charging a hot gas to the furnace for gasifying the fuel prior oxidizing the gasified hot fuel.

According to a further embodiment, charging the fuel to the furnace comprises continuously charging the fuel to the furnace and charging the hot gas to the furnace comprises continuously charging the hot gas to the furnace.

According to yet another embodiment, the method further comprises charging a raw material to the furnace prior oxidizing the gasified hot fuel.

According to another embodiment, the method further comprises cooling an exterior surface of the furnace.

According to a further embodiment, the method further comprises providing an interior surface of the furnace with a refractory material.

According to yet another embodiment, the method further comprises providing byproduct hot gas to exit the furnace while at least one of: gasifying the fuel and oxidizing a gasified hot fuel.

According to another embodiment, the metallic ore is an iron ore.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 is a front elevation cross-sectional view of a smelting apparatus in accordance with an embodiment; and

FIG. 2 is a front elevation cross-sectional view of a smelting apparatus in accordance with another embodiment.

It will be noted that throughout the appended drawings, like features are identified by like reference numerals.

### DETAILED DESCRIPTION

In embodiments there are disclosed smelting apparatus and methods of operating the same.

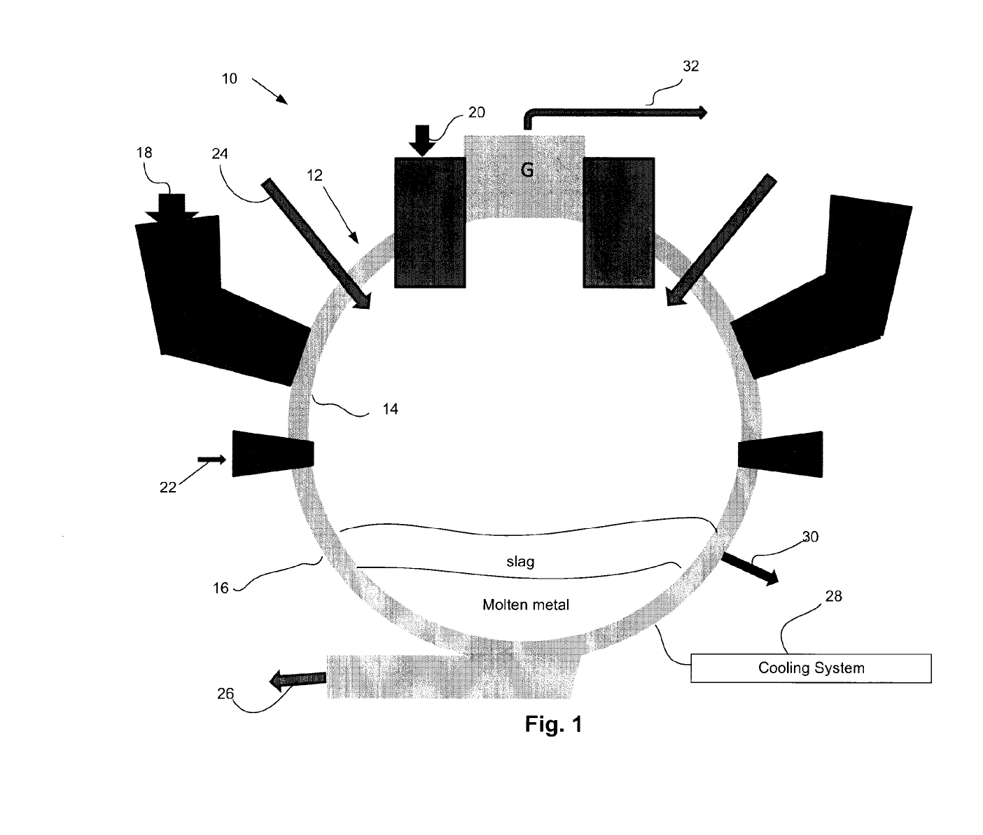

Referring now to FIG. 1 and according to an embodiment, there is shown a smelting apparatus 10. The smelting apparatus 10 is for smelting metallic ores. The smelting apparatus 10 includes a horizontally oriented cylindrical furnace 12 which has an interior surface 14 and an exterior surface 16. The smelting apparatus 10 further includes a fuel inlet 18 which is operatively connected to the furnace 12 for providing a fuel in the furnace 12. According to an embodiment, the fuel includes, without limitation, coal, petcoke, coke, biomass carbon (i.e., either powder or briquetted), and the like.

The smelting apparatus 10 further includes a raw material inlet 20 which is operatively connected to the furnace 12 for providing a raw material in the furnace 12. According to an embodiment, the raw material includes, without limitation, any fine ore which meets the overall economic requirements and additional flux materials as required for the chemical balance of the process (process reactions described below). More specifically, the raw material may be fine iron ore which meets the overall economic requirements and additional flux materials as required for the chemical balance of the process which is involved within the furnace 12.

The smelting apparatus 10 further includes a hot gas inlet 22 which is operatively connected to the furnace 12 for providing a hot gas in the furnace 12. It is to be mentioned that while any hydrocarbon gas can be used, natural gas is an economically viable choice. The smelting apparatus 10 further includes a combustion air inlet 24 which is operatively connected to the furnace 12 for providing air inducing combustion in the furnace 12. It is to be mentioned that, while the furnace 12 is in operation, combustion from combustion air entering the furnace 12 via combustion air inlet 24, is not complete to provide oxidation in the second step of the chemical reaction.

The purpose of the oxidation is to produce a mix of primarily CO and some CO₂ which will react with the ore thereby removing oxygen from the ore, reducing the ore to the metallic form and shifting the gas composition to primarily CO₂.

It is to be mentioned that the amount of heat needed for the smelting process involved within the furnace 12 is internally provided within the furnace 12.

The smelting apparatus 10 further includes a metal outlet 26 which is operatively connected to the furnace 12 for the metal to exit (i.e., continuously exit) the furnace 12. The smelting apparatus 10 may further include a slag outlet 30 which is operatively connected to the furnace 12 for slag to exit (i.e., periodically exit) the furnace 12. The slag is made from the non-metallic elements in the ore and the fluxes added with the raw material charge to assure that the slag is molten at the furnace operating temperature.

Additionally, according to an embodiment, the smelting apparatus 10 further includes a byproduct hot gas outlet 32 operatively connected to the furnace 12 for the byproduct hot gas to exit the furnace 12. After the various chemical reactions are completed within the furnace 12 and the ore is reduced to metal, the byproduct hot gas is a combination of CO, CO₂ and N₂ (in the case when natural gas is the fuel).

According to another embodiment, the interior surface 14 is refractory lined. The refractory material used for the interior surface 14 may include, without limitation, various carbon based materials and Al₂O₃ based materials.

According to another embodiment, the refractory materials used will vary depending on their location within the furnace 12 as a function of process temperature and location. For example, various carbon based materials may be used in the lower portion of the furnace 12, while Al₂O₃ based materials may be used in the upper portion of the furnace 12. Both preformed fired bricks and castable materials may be used as a function of location and economics.

According to another embodiment, the smelting apparatus 10 may further include a cooling system 28 which may be operatively connected to the furnace 12 for cooling the exterior surface 16 of the furnace 12. The furnace 12 may be cooled with water based on economics. Water may be recirculated through a common heat exchanger and reused as the cooling agent or fluid.

According to an embodiment, there is provided a smelting apparatus 10 for smelting metallic ore. The smelting apparatus 10 comprises a furnace 12 having a continuous curved wall 15 and end walls (not shown) defining a longitudinal volume having a longitudinal axis in a horizontal direction. The continuous curved wall 15 has a lowermost area 17. The longitudinal volume is divided in at least three longitudinal layers comprising a top layer (A) within which gasified fuel is combusted for creating a hot gas composition at a temperature sufficient to release, from the metallic ore, at least molten metal and slag, a lowermost layer (C) at the lowermost area for holding molten metal, and a mid layer (B) above the lowermost layer in which the slag accumulates.

In operation, within the furnace 12, the fuel is gasified to create a hot fuel gas that is combusted by the combustion air creating a hot gas composition and a temperature to smelt the metallic ores. For iron ores, these chemical reactions occurring within the furnace 12 result in the following chemical formulas:

C+O₂=CO+CO₂(Fuel Gasification)

CO+FeO=CO₂+Fe

C+CO₂=2CO

It is to be noted that similar reactions may occur within the furnace 12 for other metallic elements that are in the ore (other than iron).

The smelting apparatus 10 as described above utilizes a horizontally oriented cylindrical furnace 12 defining a horizontal axis which combines the low height approach of the box concept with the inherent refractory stability of the cylindrical approach.

According to another embodiment, the smelting apparatus 10 may be used to process mine and steel mill waste products.

According to a further embodiment, the smelting apparatus 10 may be used with a broad range of carbon sources. As mentioned above, carbon sources may include, without limitation, coal, charcoal, coke, petcoke, and biomass (i.e., sawdust), and the like.

According to yet another embodiment, the smelting apparatus 10 may be used for other metals, such as, without limitation, silver, copper and other base metals from their ores.

The smelting apparatus 10 has a horizontally oriented cylindrical furnace 12. The system capacity operating the smelting apparatus 10 may be expanded readily by making the furnace 12 longer. Both diameter and length may be variable. As such, doubling the length would double the production rate and doubling the diameter would quadruple the production rate.

According to an embodiment, the interior diameter of the furnace 12 may vary from about 3 meters to about 6 meters and the length of the furnace 12 may vary from about 6 meters to about 30 meters, as a function of a desired production capacity. For example, the capacity of the smelting apparatus may be about 1,500 tons or more of molten metal per day.

The smelting apparatus 10 may further include, without limitation, hot air delivery options, tuyeres (i.e., ceramic tuyeres, cast metal water cooled tuyeres and/or uncooled ceramic tuyeres), continuous casting, raw material charging options and the like (not shown).

According to another embodiment, the furnace 12 may be filled utilizing a static multi-point raw material charging system to provide the raw material to the raw material inlet 20 and into the furnace 12.

The furnace 12 has a low height design which eliminates the requirement for physically strong fuel, such as, without limitation, metallurgical coke. The low height design of furnace 12 also eliminates the requirement for important structural support under the furnace 12.

The furnace 12 may have a refractory lining extending from the interior surface 14 which is inherently stable under operating conditions. This configuration allows long furnace life and stable operating conditions.

Thus, during operation of the smelting apparatus 10, the fuel is charged to the furnace 12 via the fuel inlet 18. The fuel may be lump carbonaceous fuel or any other suitable fuel. The fuel may be continuously charged to the furnace 12. Alternatively, the fuel may also be fed in batch to the furnace 12. The fuel inlet 18 may be located on the side of the furnace 12, or at any location at the periphery of the furnace 12 such as to fluidly connect the fuel inlet 18 and the furnace 12.

The raw material is charged to the furnace 12 via the raw material inlet 20. The raw material may be continuously charged to the furnace 12 or charged in a batch operation to the furnace 12. The raw material may be fed on the top of the furnace 12 via the raw material inlet 20.

The hot gas may be injected to the furnace 12 via the hot gas inlet 22. The hot gas may be, without limitation, hot blast air. The hot gas may be injected via the hot gas inlet 22 below the carboneous fuel inlet 18, or at any location at the periphery of the furnace 12.

Combustion air is injected to the furnace 12 via the combustion air inlet 24. The combustion air may be post combustion air and may be injected to the furnace 12, without limitation, at the base of the raw material inlet 20.

The carbonaceous fuel is then gasified in an oxygen lean environment to create a hot fuel gas that is combusted by the post combustion air creating the necessary hot gas composition and temperature to smelt the ore feed.

The smelted ore descends to the base of the furnace 12 where the metal will separate from the non-metallic components (i.e., slag). The metal is cast (or continuously cast) from the metal outlet(s) 26 of the furnace 12. It is to be noted that the metal outlet 26 may be located at the bottom portion of the furnace 12. Only a few inches of molten metal need to be left in the bottom portion of the furnace 12 to prevent gas communication from the bottom portion such as to prevent oxygen to enter the furnace 12.

The slag may be cast (or periodically cast) from the furnace 12 via the slag outlet(s) 30 by opening a recess on the side of the furnace 12 to allow the slag to exit the furnace 12 or by periodically drilling a hole in the wall of the furnace 12 at the height of the slag (at the mid layer) to enable the slag to exit the furnace 12. The furnace byproduct gas (N₂, CO and CO₂) leaves the furnace 12 via the byproduct hot gas outlet(s) 32 to be transferred to environmental treatment and subsequent energy recovery. It is to be mentioned that the byproduct hot gas may be, without limitation, reused within the hot gas (or hot blast), sold as a fuel, used/sold to heat a boiler to produce electricity, and the like (depending on the geographical location).

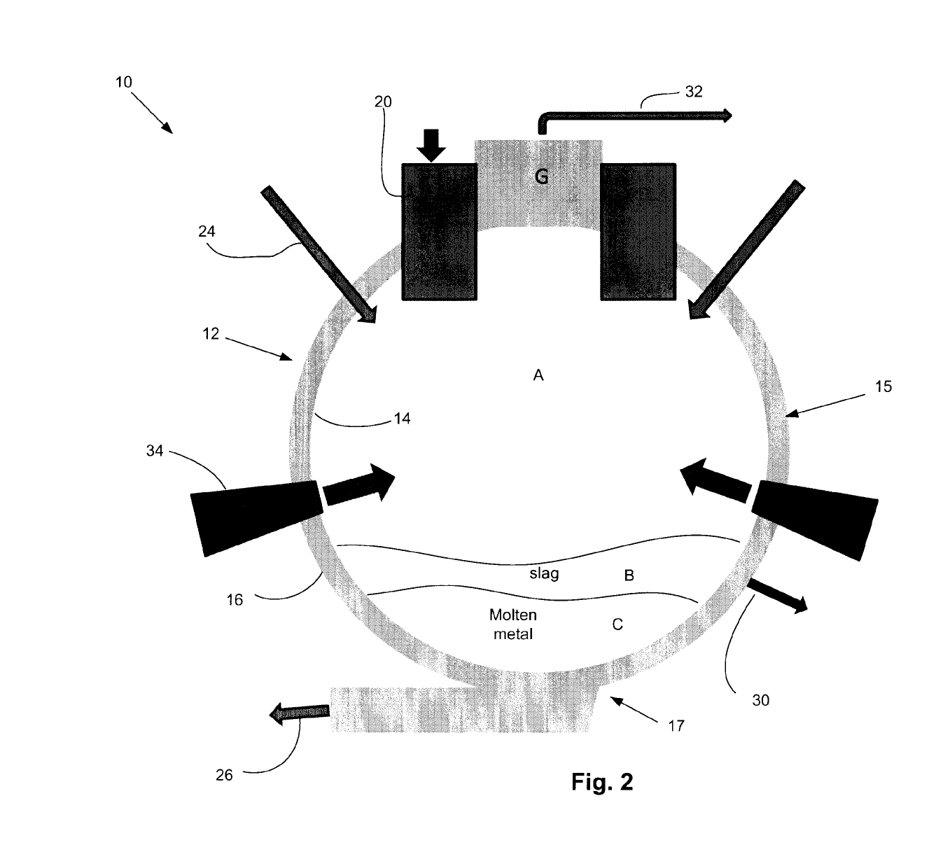

According to another embodiment and referring now to FIG. 2, the furnace 12 may include gas burner(s) or hot gas generator(s) which is connected to a gasified fuel inlet 34 that will replace the use of the carbonaceous fuel inlet 18 and of the hot gas inlet 22 (i.e., the use of solid fuel and hot air blast). The hot products of combustion may provide the necessary thermal energy to assure molten products, metal and slag, at the outlets 26, 30 of the furnace 12. The primary charge material, self-reducing briquettes may be adjusted in their overall chemistry to offset any changes in the overall furnace chemical balance.

According to another embodiment, it is to be noted that all inlets and outlets 18, 20, 22, 24, 26, 30, 32 of the furnace 12 may include a plurality of inlets/outlets as a function of the overall length and/or diameter of the furnace 12.

One of the advantages of the smelting apparatus 10 as described above is the horizontal orientation of the cylindrical design, which utilizes the pressure containment advantages of the cylindrical approach (vertically oriented cylindrical approach) without the cost disadvantages of high construction, while avoiding the refractory instability associated with the rectangular approach (horizontally oriented rectangular approach). According to the configuration of the smelting apparatus 10 as described above, no induction/electrical heating (i.e., which is costly and less efficient) is employed for providing heat to the interior of the furnace 12, all the heat required for the process is generated from the carbon (i.e., lump carbonaceous fuel) charged to the furnace 12. Furthermore, the furnace 12 is fixed; i.e., it does not rotate.

According to the configuration of the smelting apparatus 10, there is no accumulation of the molten metal in the furnace 12 and the process is not dependent on this accumulation. All metal produced is continuously cast from the furnace 12.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A smelting apparatus for smelting metallic ore, the smelting apparatus comprising a furnace having a continuous curved wall and end walls defining a longitudinal volume having a longitudinal axis in a horizontal direction, the continuous curved wall having a lowermost area, wherein the longitudinal volume is divided in at least three longitudinal layers comprising a top layer within which gasified fuel is combusted for creating a hot gas composition at a temperature sufficient to release, from the metallic ore, at least molten metal and slag, a lowermost layer at the lowermost area for holding molten metal, and a mid layer above the lowermost layer in which the slag accumulates.

2. The smelting apparatus of claim 1, wherein the continuous curved wall forms a cylinder.

3. The smelting apparatus of claim 1, wherein the continuous curved wall forms an edgeless curve.

4. The smelting apparatus of claim 1, further comprising a raw material inlet within the continuous curved wall in fluid communication with the top layer for supplying the metallic ore to the furnace.

5. The smelting apparatus of claim 4, further comprising a combustion air inlet within the continuous curved wall in fluid communication with the top layer for providing air for inducing combustion in the furnace.

6. The smelting apparatus of claim 5, further comprising a molten metal outlet in the lowermost area of the continuous curved wall in fluid communication with the lowermost layer for allowing molten metal to exit the furnace continuously and selectively.

7. The smelting apparatus of claim 6, wherein byproduct gases are released from the metallic ore and hot gas composition, and further wherein the continuous curved wall comprises an uppermost area which comprises a byproduct hot gas outlet fluidly connected to the furnace providing an exit from the furnace for the byproduct gases.

8. The smelting apparatus of claim 7, further comprising a fuel inlet within the continuous curved wall in fluid communication with the top layer for supplying a fuel to the furnace and a hot gas inlet within the continuous curved wall in fluid communication with the top layer for supplying a hot gas to the furnace for gasifying the fuel and thereby producing the gasified fuel.

9. The smelting apparatus of claim 7, further comprising a hot gas generator for providing gasified fuel and a gasified fuel inlet within the continuous curved wall in fluid communication with the top layer for supplying gasified fuel to the furnace.

10. The smelting apparatus of claim 1, wherein the furnace comprises an interior surface, the interior surface being lined with a refractory material.

11. The smelting apparatus of claim 1, further comprising a cooling system operatively connected to the furnace for cooling an exterior surface of the furnace.

12. A method for smelting a metallic ore comprising:
within a furnace having a continuous curved wall and end walls defining a longitudinal volume having a longitudinal axis in a horizontal direction, combusting a gasified fuel for creating a hot gas composition at a temperature to release, from the metallic ore a molten metal.

13. The method of claim 12, further comprising charging a raw material to the furnace prior oxidizing the gasified fuel.

14. The method of claim 13, further comprising:
supplying a fuel to the furnace; and
supplying a hot gas to the furnace for gasifying the fuel prior combusting the gasified fuel.

15. The method of claim 13, further comprising supplying gasified fuel to the furnace.

16. The method of claim 12, further comprising cooling an exterior surface of the furnace.
